(19) United States
(12) Patent Application Publication
(10) Pub. No.: US 2009/0073962 A1
(43) Pub. Date: Mar. 19, 2009

(54) Modular messaging log application on an IP phone

(75) Inventor: Savita S. Muttagi, Cybercity Magarpatta City (IN)

Correspondence Address: COHEN, PONTANI, LIEBERMAN & PAVANE LLP, 551 FIFTH AVENUE, SUITE 1210, NEW YORK, NY, 10176, US

(73) Assignee: Avaya Technology LLC, Basking Ridge, NJ (US)

(21) Appl. No.: 11/901,510

(22) Filed: Sep. 18, 2007

(51) Int. Cl. H04L 12/66

(52) U.S. Cl. 370/352; 379/93.24

(57) ABSTRACT

Presented is a method for selectively retrieving voice messages. The method includes accessing a list of received calls, and accessing a subset of the list of received calls. Each of the calls in the subset has an associated stored message. The method further includes selectively accessing information associated with a particular call in the subset of received calls, and retrieving the message associated with the particular call. Also presented is an internet protocol (IP) phone that includes a screen configured to display a list of received calls, a soft key configured to display a subset of the list of received calls when pressed. Each of the calls in the subset has an associated stored message. The phone further includes soft keys configured to selectively display information associated with a particular call in the subset of received calls when pressed, and retrieve the message associated with the particular call when pressed.

### BACKGROUND OF THE INVENTION

1. Field of the Invention

The present invention relates generally to IP telephone call logs, and more particularly to an IP phone that includes a modular messaging log from which a user can selectively access voice messages.

2. Description of the Related Art

In a corporate or industrial setting, phone usage by employees is monitored through call logs. A call log is a log of all the phone usage (i.e., incoming and outgoing calls and the time and date for each call) for each phone extension that is registered with a company's phone system communication manager. Typically, for each phone extension, the call log includes a list of extensions that were called by the user of the particular phone extension (i.e., outgoing calls), and a list of extensions that were called in to the user's phone extension (i.e., received or incoming calls). A call log is accessible by a user via the user's phone to view calls made and received, and can be used by the user to redial a previously called extension or dial an extension to return a received call.

Incoming or received calls fall into one of three categories, which include: incoming calls that were answered, incoming calls that were “missed” (i.e., the user of the extension did not answer the phone) where no message was left, and incoming calls that were missed where a message was left. Current call logs provide an indication that a particular received call was either answered or missed. However, current call logs do not distinguish between missed calls where a message was left and missed calls as to which no message was left.

In existing corporate phone systems, when a call is missed and a message is left, a message light on the phone unit flashes to alert the user of one or more existing messages. To retrieve phone messages, a user must access the company's voice mail system (e.g., audix) and sequentially advance through each and every message to discover the important ones. Currently, there is no means for a user to determine which missed calls include messages, and no means to selectively prioritize retrieval of phone messages.

### SUMMARY OF THE INVENTION

In one aspect, the invention involves a method for selectively retrieving voice messages from a terminal device. The method includes accessing a list of calls placed from and received by the terminal device, accessing a subset of the list of calls, where each of the calls in the subset has an associated stored message, selectively accessing information associated with a particular call in the subset of received calls, and retrieving the message associated with the particular call.

In one embodiment, the method includes adding the information to an electronic phonebook. In another embodiment, the method includes calling an extension associated with the particular call. In still another embodiment, the method includes deleting the particular call from the subset of calls. In other embodiments, the information includes a name of the caller, the extension of the caller, and the date and time of the call. In still another embodiment, retrieving the message includes retrieving the message from a modular messaging server.

In yet another embodiment, the step of accessing a subset of the list of calls includes displaying the subset of the list of calls, and the step of selectively accessing information associated with a particular call includes selecting a particular call from the subset of the list of calls.

In another aspect, the invention involves an internet protocol (IP) phone. The IP phone includes a screen configured to display a list of calls placed from and received by the IP phone. The IP phone further includes at least one soft key configured to: display on the screen a subset of the list of calls when the at least one soft key is accessed, each of the calls in the subset having an associated stored message, selectively display on the screen information associated with a particular call in the subset of received calls when the at least one soft key is accessed, and retrieve the message associated with the particular call when the at least one soft key is accessed.

In one embodiment, the at least one soft key is configured to add the information to an electronic phonebook when the at least one soft key is accessed. In another embodiment the at least one soft key is configured to call an extension associated with the particular call when the at least one soft key is accessed. In yet another embodiment, the at least one soft key is configured to delete the particular call from the subset of received calls when the at least one soft key is accessed. In still another embodiment, the information includes a name of the caller, the extension of the caller, and the date and time of the call. In other embodiments, the message is stored on a modular messaging server.

In still another aspect, the invention involves an internet protocol (IP) phone messaging system. The system includes a plurality of IP phones. Each IP phone includes a screen configured to display a list of calls placed from and received by the IP phone, and at least one soft key. The at least one soft key is configured to display on the screen a subset of the list of calls when the at least one soft key is accessed, where each of the calls in the subset has an associated stored message. The at least one soft key is also configured to selectively display on the screen information associated with a particular call in the subset of calls when the at least one soft key is accessed, and retrieve the message associated with the particular call when the at least one soft key is accessed. The system further includes a communication manager in communication with each of the plurality of IP phones, and a modular messaging server in communication with the communication manager and in communication with each of the plurality of IP phones via the communication manager.

In one embodiment, the at least one soft key is configured to add the information to an electronic phonebook when pressed. In another embodiment, the at least one soft key is configured to call an extension associated with the particular call when pressed. In still another embodiment, the at least one soft key is configured to delete the particular call from the subset of received calls when pressed. In other embodiments, the information includes a name of the caller, the extension of the caller, and the date and time of the call. In still another embodiment, the message is stored on the modular messaging server.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, like reference characters refer to the same parts throughout the different views. Also, the drawings are not necessarily to scale, emphasis instead generally being placed upon illustrating the principles of the invention.

FIG. 1 is an illustrative block diagram of an IP phone system, according to one embodiment of the invention;

FIG. 2 is an illustrative diagram of an IP phone main screen including various soft keys, according to one embodiment of the invention;

FIG. 3 is an illustrative diagram of an IP phone call log screen including various soft keys according to one embodiment of the invention;

FIG. 4 is an illustrative diagram of an IP phone modular message log (MMLOG) screen including various soft keys, according to one embodiment of the invention;

FIG. 5 is an illustrative diagram of an IP phone MMLOG screen for a particular MMLOG entry including various soft keys, according to one embodiment of the invention;

FIG. 6 is an illustrative flow diagram of the operation of an IP phone system that includes a modular messaging log application, according to one embodiment of the invention;

FIGS. 7A and 7B are illustrative flow diagrams of the operation an IP phone system when a user B does not answer a call from a user A, according to one embodiment of the invention; and

FIG. 8 is an illustrative flow diagram of the steps for viewing missed calls with messages and retrieving the messages, according to one embodiment of the invention.

### DETAILED DESCRIPTION OF THE PRESENTLY PREFERRED EMBODIMENTS

The present invention involves an IP phone that includes a modular messaging log application that distinguishes between missed calls where a message was left and missed calls as to which no messages were left, and which allows a user to selectively access voice messages.

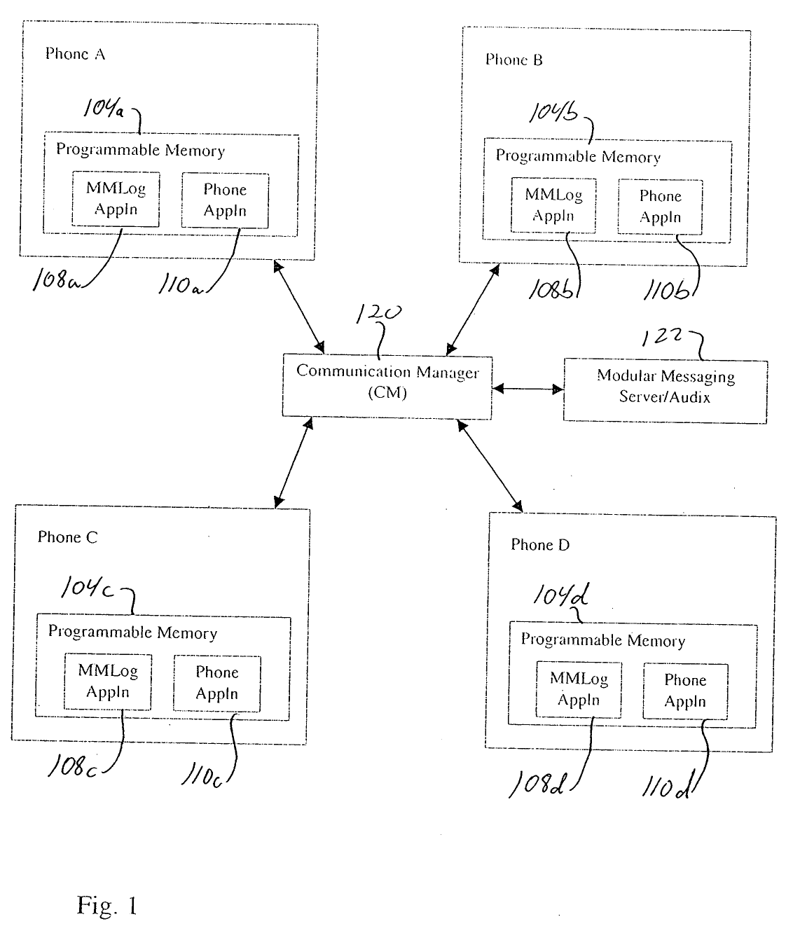

Referring to FIG. 1, in one embodiment, an illustrative block diagram of an IP phone system 100 that includes the modular messaging log application of the present invention. The system 100 includes IP phone A, IP phone B, IP phone C, IP phone D, Communication Manager/Gateway (CM) 120, and a modular messaging server/Audix 122. In the embodiment shown in FIG. 1, only four IP phones are shown for the purpose of describing the invention. Those skilled in the art will understand that more or less IP phones can be included without departing from the spirit of the invention. Further, the technical details regarding the connection and communication of the IP phone A, the IP phone B, the IP phone C, the IP phone D, and the Communication Manager 120 are also know to those skilled in the art.

The modular messaging server/Audix 122 allows voice mail messages to be stored and retrieved by users via an IP phone (e.g., IP phone A, IP phone B, IP phone C, IP phone D), and is know to those skilled in the art. The modular messaging server/Audix 122 includes a message application server, a message store, and a directory server. The message application server provides an interface between the message store and the IP telephone system. The message store stores all voice mail messages. The directory server contains information about the users of the IP telephone system.

Each IP phone A-D includes a programmable memory 104a-d, respectively. Such programmable memory 104a-d includes, but is not limited to SRAMs, EPROMs, and EEPROMs. For each IP phone A-D, a modular messaging application 108a-d and an IP phone application 110a-d are firmware that is stored in the programmable memory 104a-d. In another embodiment, the modular messaging application 108a-d is incorporated into, or part of the IP phone application 110a-d. In either embodiment, the modular messaging application 108a-d and the IP phone application 110a-d are loaded and executed when the phone receives power. In still another embodiment, the modular messaging application 108a-d and the IP phone application 110a-d are stored in a programmable memory and loaded into a processor when the IP phone receives power. In yet other embodiments, the firmware is stored and executed by other methods known in the art.

The firmware of the present invention augments existing IP phone firmware by providing additional soft keys to an IP phone's call log menu that enable a user, inter alia, to view a list of missed calls, determine which of the missed calls include messages, and selectively play the messages in any order the user desires regardless of the order in which the messages were left. Thus, the user can listen to important messages first, and listen to less important messages last or at a later time.

Before a particular IP phone (e.g., IP phone A-D) can be used, the firmware (modular messaging application 108a-d and the IP phone application 110a-d) are first loaded into the memory 104a-d of a particular IP phone (e.g., IP phone A-D) as binary files via an hypertext transfer protocol (HTTP) sever or a transport layer security (TLS) server, and the phones A-D are then registered with the Communication Manager 120. A phone is registered with the Communication Manager 120 by giving the IP phone a valid extension, a password administered on the Communication Manager 120, and a coverage path. The IP phone registration can be accomplished using methods known in the art.

A coverage path is a list of extensions where a call is sequentially routed when the call is not answered at the desired extension. For example, the coverage path for an executive might include: the executive's extension, her assistant's extension, and then a voice messaging system. When an employee calls the executive and the executive does not answer, the call is routed to the assistant. If the assistant also does not answer, the call is routed to the company voice messaging system.

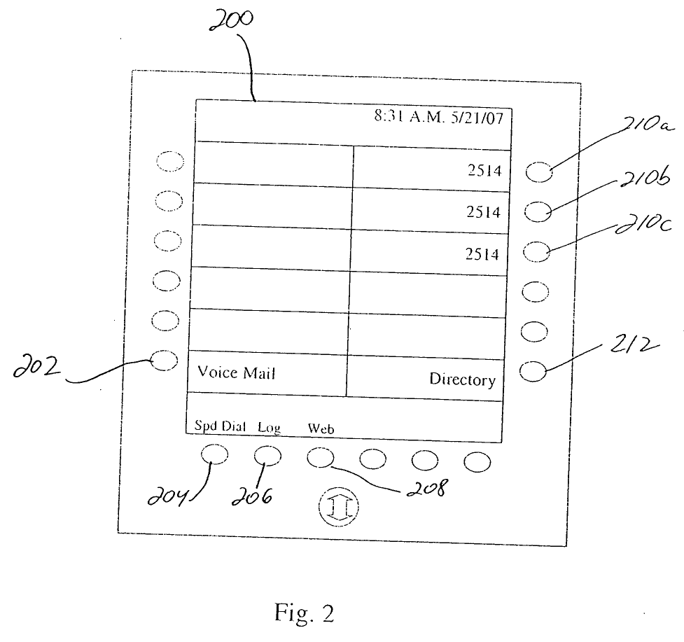

Referring to FIG. 2, in one embodiment, an illustrative diagram of an IP phone main screen 200 including various soft keys is shown. The soft keys include, but are not limited to, a voice mail access soft key 202, a “spd dial” (speed dial) soft key 204, a “log” soft key 206, a “web” soft key 208, extension line soft keys 210a-c, and a “directory” soft key 212. When a user wishes to access his/her call logs, the user presses the log soft key 206.

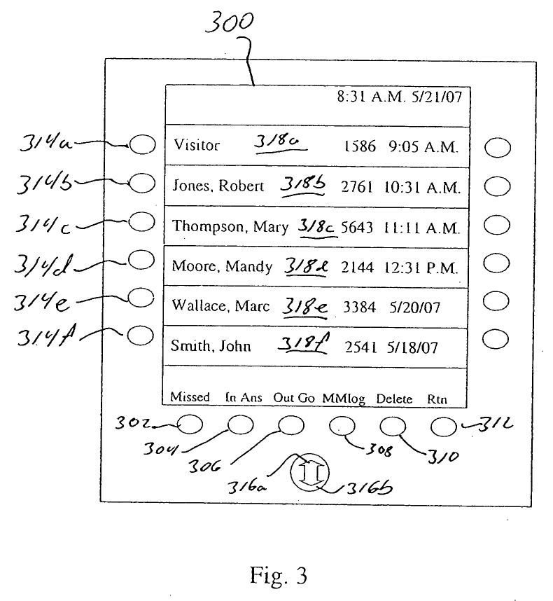

Referring to FIG. 3, in one embodiment, an illustrative diagram of an IP phone call log screen 300 including various soft keys is shown. The various soft keys include a “Missed” call log soft key 302, an “In Ans” call log soft key 304, an “Out Go” call log soft key 306, an “MMLOG” call log soft key 308, a “Delete” soft key 310, a “Rtn” (return) soft key 312 and call select soft keys 314a-f. The screen 300 shows a cumulative list of all calls made from, and received on, the particular phone. The list includes the names of people 318a-f who were either called or who called the user and their associated extensions. When the user presses the “Missed” soft key 302, the user is presented with a similar list of names and extensions that includes only incoming calls that were missed and where no message was left. When the user presses the “In Ans” soft key 304, the user is presented with a similar list of names and extensions that includes only incoming calls that were answered. When the user presses the “Out Go” soft key 306, the user is presented with a similar list of names and extensions that includes only out going calls that were made from the particular phone. When the user presses the “MMLOG” soft key 308, the user is presented with a modular message log. The module message log includes a similar list of names and extensions and includes only incoming calls that were missed where a message was left. When the user presses the “Delete” soft key 310, the log is cleared. When the user presses the “Rtn” soft key 312, the previous screen is displayed. The IP phone also includes scroll keys 316a-b, which allows the user to scroll though the call log.

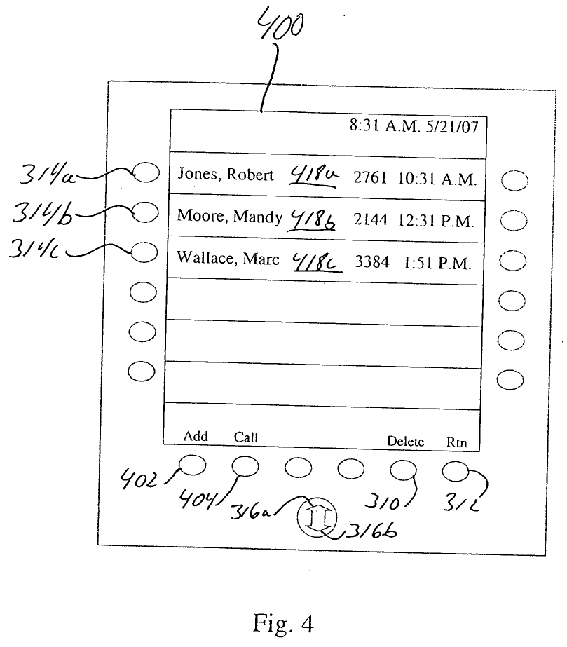

Referring to FIG. 4, in one embodiment, an illustrative diagram of an IP phone modular message log (MMLOG) screen 400 including various soft keys is shown. The various soft keys include an “Add” soft key 402, a “Call” soft key 404, the “Delete” soft key 310, and the “Rtn” soft key 312. A user uses the scroll keys 316a-b to scroll through the list of calls and select a particular name 418a-c. When the user presses the “Add” soft key 402, the information associated with the selected name is added to the user's phonebook or contacts. When the user presses the “Call” soft key 404, the phone number associated with the selected name is automatically dialed. When the user presses the “Delete” soft key 310, the information associated with the selected name is deleted from the MMLOG. When the user presses the “Rtn” soft key 312, the previous screen 300 is displayed.

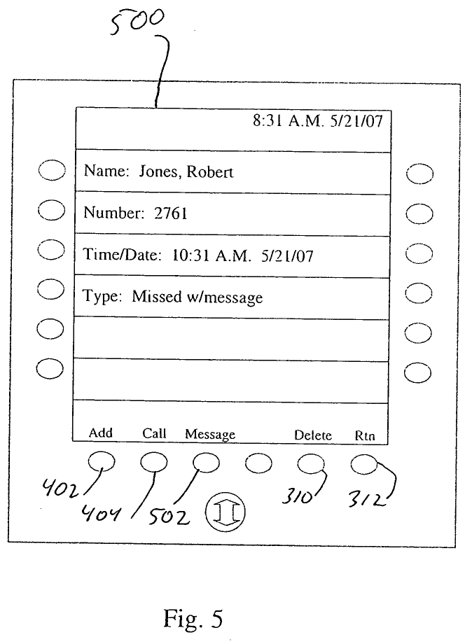

As previously described, the modular message log includes a list of only names and extensions 418a-c associated with missed calls where a message was left. When a user presses one of the call select soft keys 310a-f, the user is presented with a screen that provides further details for the particular missed call with a message left, as shown in FIG. 5.

Referring to FIG. 5, in one embodiment, an illustrative diagram an IP phone MMLOG screen 500 for a particular MMLOG entry including various soft keys is shown. The various soft keys include an “Add” soft key 402, a “Call” soft key 404, a “Message” soft key 502, a “Delete” soft key 310, and the “Return” soft key 312. When the user presses the “Add” soft key 402, the information displayed on the screen 500 is added to the user's phonebook or contacts. When the user presses the “Call” soft key 404, the extension shown in the screen 500 is automatically dialed. When the user presses the “Message” soft key 502, the user is connected to the modular messaging server 122 (FIG. 1) via the communication manager 120 so that the user can retrieve the specific message left from the extension currently displayed on the screen 500. When the user presses the “Delete” soft key 310, the displayed entry is deleted from the MMLOG shown on screen 400 (FIG. 4). When the user presses the “Rtn” key 312, the previous screen 400 is displayed.

In another embodiment, the “Message” soft key 502 is included on the modular message log (MMLOG) screen 400. In this embodiment, user B can select a particular call using the scroll keys 316a-b and retrieve the associated message. In still another embodiment, the above-described functions can be implemented using hard keys rather than soft keys.

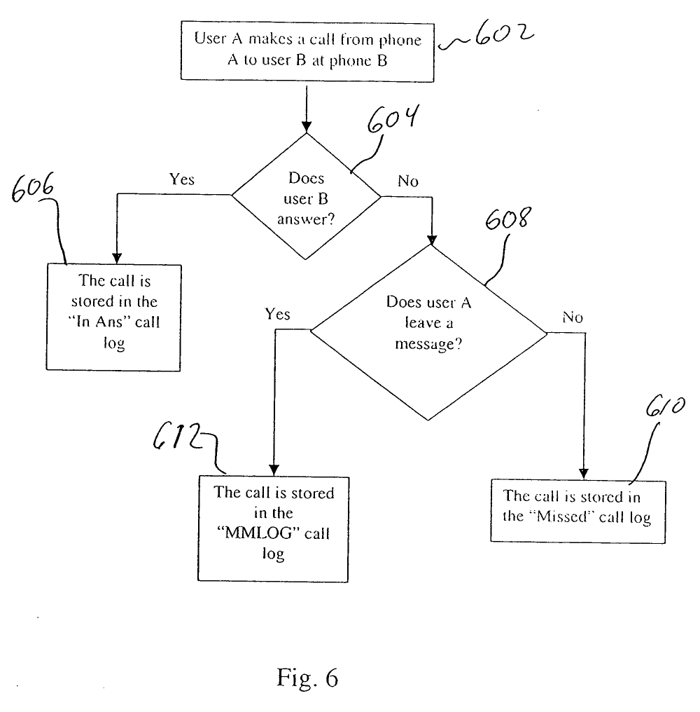

Referring to FIG. 6, in one embodiment, an illustrative flow diagram of the operation of an IP phone system that includes a modular messaging log application is shown. A user “A” from an IP phone A makes a call to a user “B” associated with an IP phone B (see FIG. 1) (Step 602). Next, the Communication Manager 120 determines if user B answers the call from user A (i.e., user A picks up the phone A) (Step 604). If user B answers the call from user A, the Communication Manager 120 updates the call log for user B by adding user A's name, extension, and time and date of the call to user B's “In Ans” call log (Step 606). If user B does not answer the call from user A, the Communication Manager 120 determines if user A leaves a message (Step 608).

If user A does not leave a message, the Communication Manager 120 updates the call log for user B by adding user A's name, extension, and time and date of the call to user B's “Missed” call log (Step 610). If user A does leave a message for user B, the Communication Manager 120 updates the call log for user B by adding user A's name, extension, and time and date of the call to user B's “MMLOG” call log (Step 612).

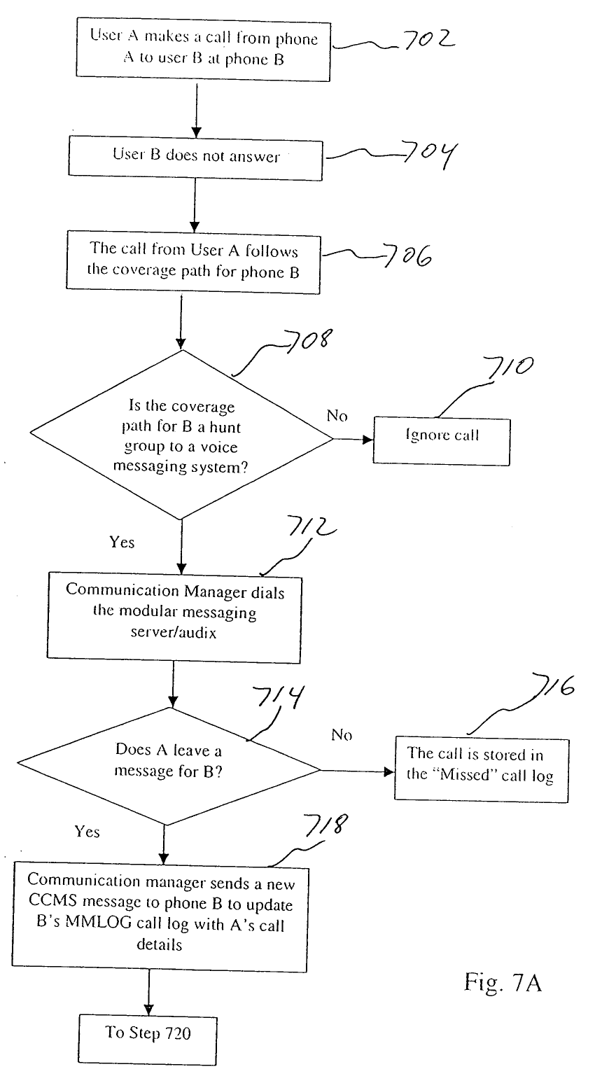

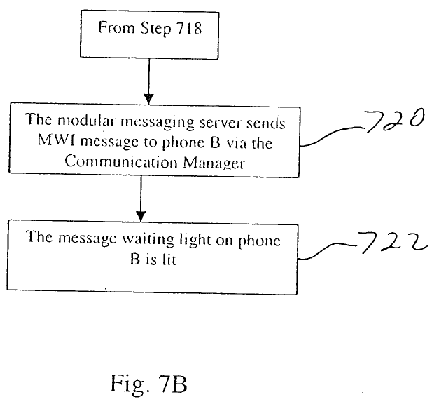

FIGS. 7A and 7B are illustrative flow diagrams of the operation the IP phone system when user B does not answer a call from user A. As previously described above, a user “A”, from an IP phone A, makes a call to a user “B” associated with an IP phone B (Step 702), and user B does not answer the call (within a preset number of rings) from user A (Step 704). At this point, the call from user A follows the coverage path for phone B (Step 706). The Communication Manager 120 next determines if the coverage path for phone B is a hunt group to the modular messaging server 122 (Step 708). A hunt group allows for automatic distribution of incoming calls to two or more extensions, and must include the modular messaging server 122 to enable a user to leave a message. If the coverage path is not a hunt group to a voice messaging system, (e.g., modular messaging server/Audix 122) the missed call is ignored (Step 710). If the coverage path is a hunt group to a voice messaging system, the Communication Manager 120 dials and connects to the modular messaging server/Audix 122 (Step 712). The Communication Manager then determines if user A actually leaves a message for user B (Step 714). If user A does not actually leave a message for user B, the Communication Manager 120 updates the call log for user B by adding user A's name, extension, and time and date of the call to user B's “Missed” call log (Step 716). If user A leaves a message for user B, the Communication Manager 120 sends a control channel message setup (CCMS) message to phone B to update the call log for user B by adding user A's name, extension, and time and date of the call to user B's “MMLOG” call log (Step 718). If user A, during the attempted phone call, reaches a point where he/she is to leave a message, but instead hangs up, the Communication Manager 120 sends a control channel message setup (CCMS) message to phone B to update the call log for user B by adding user A's name, extension, and time and date of the call to user B's “MMLOG” call log as in step 718. However, the message would simply be empty (i.e., nothing would be played back when the user B accesses the message (described below).

Next, the modular messaging server 122 sends a message waiting indictor (MWI) message to phone B via the Communication Manager 120 (Step 720). In response to the MWI, the message waiting light on phone B is lit (Step 722).

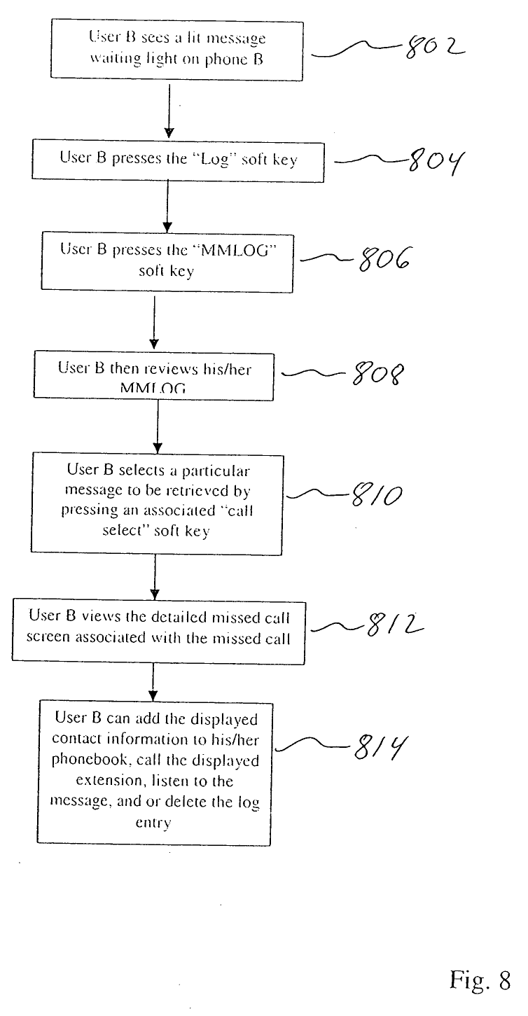

Referring to FIG. 8, in one embodiment, an illustrative flow diagram of the steps for viewing missed calls with messages and retrieving the messages is shown. User B first returns to his/her office and is alerted by the message waiting light on phone B that one or more messages has been received (Step 802). User B then accesses his/her logs by pressing the “Log” soft key 206 (FIG. 2) (Step 804). User B then accesses his/her MMLOG by pressing the “MMLOG” soft key 308 (FIG. 3) (Step 806). User B then reviews his/her MMLOG to determine which messages he/she wants to retrieve (FIG. 4) (Step 808). User B selects a particular message to be retrieved by pressing the “call select” soft key 314a-f associated with the particular message to be retrieved (Step 810). User B is then presented with the detailed missed call screen 500 associated with the selected call (FIG. 5) (Step 812). User B can then add the caller's information to his/her address book by pressing the “Add” soft key 502, call the caller by pressing the “Call” soft key 504, listen to the message left by the caller by pressing the “Message” soft key 506, or delete the log entry by pressing the “Delete” soft key 310 (Step 814).

Each message listed in the MMLOG call log has an associated memory location in the modular messaging server 122. When user B selects a particular message from the MMLOG call log, the modular messaging server 122 goes to the particular memory location and retrieves the desired message for playback.

Hence, with the above-described invention, a user can easily and quickly distinguish between missed calls where a message was left and missed calls where no message was left. Further, the user can easily prioritize and selectively access specific voice messages without having to sequentially step through all stored voice messages.

Variations, modifications, and other implementations of what is described herein may occur to those of ordinary skill in the art without departing from the spirit and scope of the invention. Accordingly, the invention is not to be defined only by the preceding illustrative description. For example, the various embodiments are described as including soft keys for actuating the various features. Alternatively, a device could be designed with hard keys.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for selectively retrieving voice messages from a terminal device, comprising:
accessing a list of calls placed from and received by the terminal device;
accessing a subset of the list of calls, each of the calls in the subset having an associated stored message;
selectively accessing information associated with a particular call in the subset of received calls; and
retrieving the message associated with the particular call.

2. The method of claim 1 further comprising adding the information to an electronic phonebook.

3. The method of claim 1 further comprising calling an extension associated with the particular call.

4. The method of claim 1 further comprising deleting the particular call from the subset of calls.

5. The method of claim 1, wherein the information comprises a name of the caller, the extension of the caller, and the date and time of the call.

6. The method of claim 1, wherein retrieving the message comprises retrieving the message from a modular messaging server.

7. The method of claim 1 wherein the step of accessing a subset of the list of calls comprises displaying the subset of the list of calls, and the step of selectively accessing information associated with a particular call comprises selecting a particular call from the subset of the list of calls.

8. An internet protocol (IP) phone, comprising:
a screen configured to display a list of calls placed from and received by the IP phone;
at least one soft key configured to:
display on the screen a subset of the list of calls when the at least one soft key is accessed, each of the calls in the subset having an associated stored message;
selectively display on the screen information associated with a particular call in the subset of received calls when the at least one soft key is accessed; and
retrieve the message associated with the particular call when the at least one soft key is accessed.

9. The internet protocol (IP) phone of claim 8, wherein the at least one soft key is configured to add the information to an electronic phonebook when the at least one soft key is accessed.

10. The internet protocol (IP) phone of claim 8, wherein the at least one soft key is configured to call an extension associated with the particular call when the at least one soft key is accessed.

11. The internet protocol (IP) phone of claim 8, wherein the at least one soft key is configured to delete the particular call from the subset of received calls when the at least one soft key is accessed.

12. The internet protocol (IP) phone of claim 8, wherein the information comprises a name of the caller, the extension of the caller, and the date and time of the call.

13. The internet protocol (IP) phone of claim 8, wherein the message is stored on a modular messaging server.

14. An internet protocol (IP) phone messaging system, comprising:
a plurality of IP phones each comprising:
a screen configured to display a list of calls placed from and received by the IP phone;
at least one soft key configured to:
display on the screen a subset of the list of calls when the at least one soft key is accessed, each of the calls in the subset having an associated stored message;
selectively display on the screen information associated with a particular call in the subset of calls when the at least one soft key is accessed; and
retrieve the message associated with the particular call when the at least one soft key is accessed;
a communication manager in communication with each of the plurality of IP phones; and
a modular messaging server in communication with the communication manager and in communication with each of the plurality of IP phones via the communication manager.

15. The internet protocol (IP) phone messaging system of claim 14, wherein the at least one soft key is configured to add the information to an electronic phonebook when pressed.

16. The internet protocol (IP) phone messaging system of claim 14, wherein the at least one soft key is configured to call an extension associated with the particular call when pressed.

17. The internet protocol (IP) phone messaging system of claim 14, wherein the at least one soft key is configured to delete the particular call from the subset of received calls when pressed.

18. The internet protocol (IP) phone messaging system of claim 14, wherein the information comprises a name of the caller, the extension of the caller, and the date and time of the call.

19. The internet protocol (IP) phone messaging system of claim 14, wherein the message is stored on the modular messaging server.
